(19) United States
(12) Patent Application Publication
(10) Pub. No.: US 2002/0129113 A1
(43) Pub. Date: Sep. 12, 2002

(54) Method and arrangement relating to intelligent network services

(76) Inventor: Martin Larsson, Karlstad (SE)

Correspondence Address: BURNS DOANE SWECKER & MATHIS L L P, POST OFFICE BOX 1404, ALEXANDRIA, VA, 22313-1404, US

(21) Appl. No.: 09/751,040

(22) Filed: Dec. 29, 2000

Related U.S. Application Data
(63) Continuation of application No. PCT/SE99/01182, filed on Jun. 29, 1999.

(30) Foreign Application Priority Data
Jun. 29, 1998 (SE) 9802331-0

(51) Int. Cl. G06F 15/16; G06F 15/173

(52) U.S. Cl. 709/208; 709/219

(57) ABSTRACT

The present invention refers to an arrangement in a communications network including an Intelligent Network IN (30) including means for establishing connection with a client site through a communication link (35). The client site (15, 16, 36) includes remotely controllable devices (17-23) arranged with controlling means, and said IN (30) includes a service arrangement providing remote control service for controlling said devices in said client site (15, 16, 36).

### TECHNICAL FIELD OF THE INVENTION

The present invention relates to an arrangement in a communications network including an Intelligent Network, IN, including means for establishing connection with a client sites through a communication link.

### BACKGROUND OF THE INVENTION AND RELATED ART

Today it is not possible to obtain a simple and inexpensive arrangement for controlling automated houses, offices or plants (so-called smart houses) etc.

There are advanced services provided through the Intelligent Networks implemented in the telephony servers. The problem is that there is no known way to use the facilities provided by the IN for automating services.

The Intelligent Network is based on the central control of the telecommunication network services. Specification and implementation of new services can be achieved rapidly thanks to a modular structure and heterogeneous networks. The network serves as the basis, e.g. for Virtual Private Networks (VPNs) and Universal Personal Telecom services (UPT).

The Intelligent Network (IN) concept has been introduced as a method to enable telecom network providers to quickly implement new cost-effective network services, in particular in voice telephony.

The main contents of IN are to separate the call or Service Switching Functions (SSF) and call or Service Control Functions (SCF), traditionally located in the PSTN local exchanges. The separation generally implies the relocation of the SSF and SCF into new systems as separate network elements called Service Switching Points (SSPs) and Service Control Points (SCPs).

In the early days of IN the SSPs were implemented in public switches, while the SCPs were implemented in the switches or sometimes in general purpose mini computers. Consequently, the industry envisaged largely IN platforms as a central resource for the network operator for new service implementation.

Although, the IN offer advantages and possibilities, it has not been used to centralized home automating control points. Usually, one has to use dedicated lines from an automating centre. It is also known to use normal telephone lines or more advanced systems, for example involving ISDN (Integrated Services Digital Network.) Examples on such arrangements are found in WO 95/23391, WO 95/08891 and EP-A1-738 065.

### SUMMARY OF THE INVENTION

One of the objects of the present invention is to provide an arrangement which enables the normal public line customers to obtain an effective way to use automated hose facilities (hereinafter called Automating) through already defined services of an Intelligent Network (IN), preferably implemented in telephony services.

The invention also has as an object to provide an arrangement that makes it possible to control and manage an automated house, plant etc., through an IN-service controlled over a communication network and to the network connected terminals.

An advantage according to the present invention is that it is possible to initiate and/or run one or several Automating functions by initiating an IN service directly through a communication device, such as a phone set or a mobile phone.

Yet another advantage according to the present invention is that the Automating control centre can be implemented into an IN, enabling to offer different levels of Automating control and functions to customers, e.g. for different prices.

Therefore the arrangement according to the preamble is arranged so that said client site includes remotely controllable devices arranged with controlling means, and said IN includes a service arrangement, which provides remote control services for controlling said devices in said client site. The IN includes an Automating Service Server comprising a database containing information on the client site. The information includes at least type of communication with the client site, control means type and services available. The arrangement further includes a traffic adapter for converting control signals form the IN to a signal adapted to client site control signals. It further includes a Communication Interface for communication with the client site(s).

Advantageously, said Communication Interface includes several types of communications devices and means for encrypting/decrypting signals to the client site(s). Preferably the traffic adapter includes protocols for at least one or several of LONworks, Cebus and X-10. The IN further includes Service Switching Point and Service Control Points, which communicate with the Automating Services Server through TCP/IP.

The invention also relates to a communications network including a service provider part, a client part and communications means to connect the service provider part and the client part. The client part includes at least one remotely controllable device and the service provider part includes a service providing server. The server includes means to store information at least about the remotely controllable device and also means to provide initiation commands through the communications means when initiated by a client. Advantageously, the service providing server is part of an Intelligent Network in a telecommunication network and the client part includes a powerline network.

According to a method of invention for remotely controlling at least one device at a distant site through a communication network a remote management service is arranged in an Intelligent Network (IN), a service request is connected from a client to said service in said IN, a management command is generated by means of said service and transmitted to a location specified by the client. Preferably, the method may further include the steps of converting the management command into a form receivable by the controlled device. The service(s) is (are) provided through a subscription or by purchasing. Advantageously, the service integrated into telephony services and provided through local exchanges of a public telephone network.

### BRIEF DESCRIPTION OF THE DRAWINGS

The invention will in the following be further described in non-limiting way under reference to the accompanying drawings in which:

FIG. 1 schematically illustrates a network concept according to the invention.

FIG. 2 illustrates a schematic block diagram of a network arrangement according to the invention.

### DETAILED DESCRIPTION OF THE EMBODIMENTS

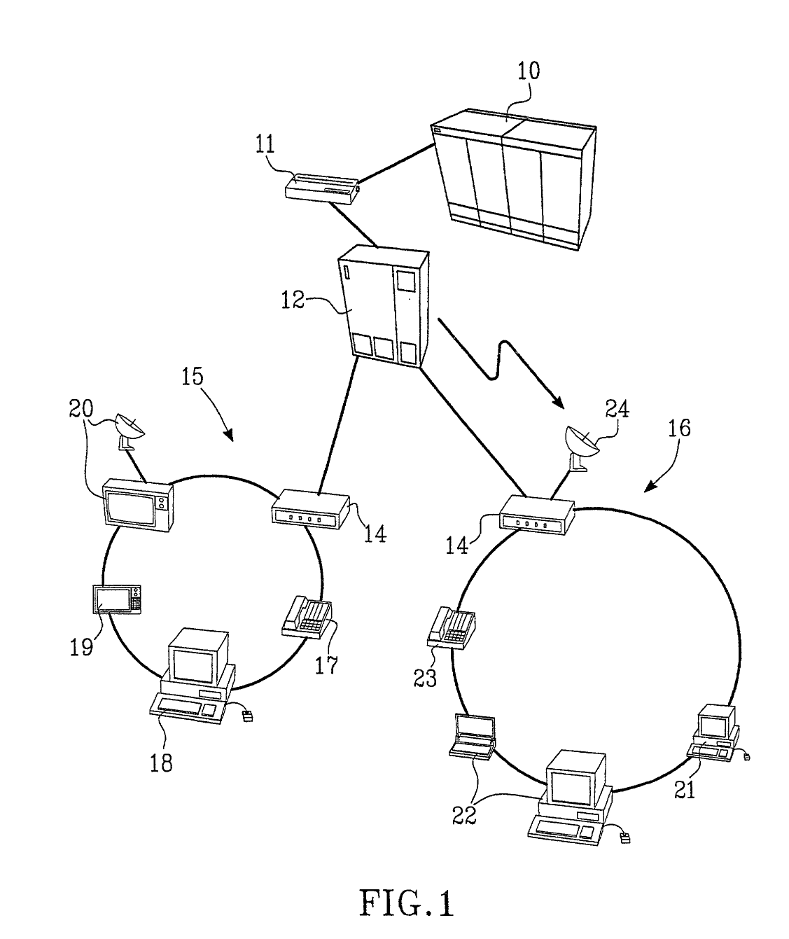

A network including means for running an automated site, such as a house, an office, a plant etc., is illustrated in FIG. 1. The network includes an Intelligent Network (IN) implemented in a PSTN local exchanges of a public telephone network. The IN according to the invention is expanded with an Automating Service SEver, ASSE, 10 including Automating Service Application, ASA. The ASSE may also include other applications.

The ASSE is connected to a Traffic Control Adapter, TCA, 11 for generating a suitable protocol which can be understood by the equipment controlled at the controlled site. The TCA may include protocols for LONwork, CeBus, X10 etc.

TCA 11 is connected to the automated site(s) via a Communication Interface CI 12 which converts and transmits control signals (protocols) to communication signals. The CI 12 may include a modem, a transmitter, a base station of a cellular communications network or wireless network etc. The communication is carried out via common telephone lines 13, radio links or any other communication links.

At the site to be controlled and/or managed, for example a home 15 or an office 16, the control signals from IN are received by means of receiving means 14 arranged standalone or in a router, or the like. The control signals are then converted to a suitable form which can be understood by the equipment to be controlled. In preferred embodiments the Local Area Network (LAN) is a powerline-based network, i.e. the equipments in the building are controlled by modulating control signals into AC power line fed to the equipments. The advantage is that the powerline carrier for home/building automating systems is easy to install because the existing AC wiring of the building can be used to carry command or control signals.

The home LAN 15 may include connections to communication devices 17, computers 18, kitchen equipments 19, audio/video equipments 20, alarm equipments and so on. The office LAN 16 is likewise connected to office machines 21, 22, communication devices 23 etc.

The communication may also be carried out through other wireless communication 24, such as the radio communication, cellular telecommunication etc.

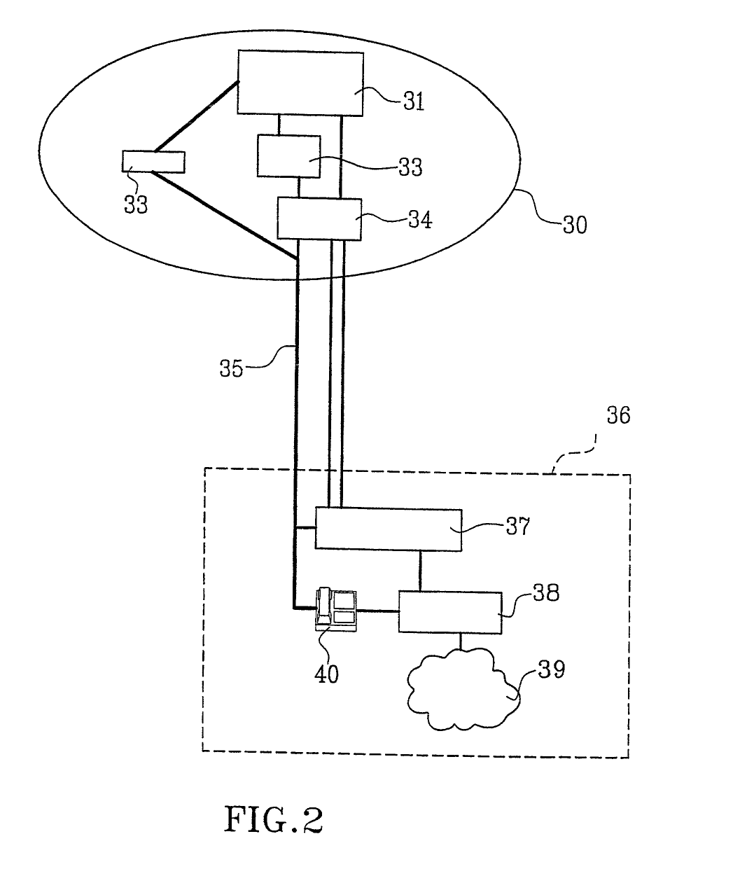

One more detailed, schematic block diagram showing a communication network according to the present invention is illustrated in FIG. 2.

The IN 30 includes the Automating Service Server 31 running AUTOMATING Services AUS. The ASSE 31 also includes storage means for storing databases for services, clients, prices etc. The ASSE 31 is connected to and controlled by the SCP 32 of the IN. A Traffic Adapter, TA, 33 communicates with the ASSE and converts the control signals generated by AUS to a suitable control protocol, which can be used at clients site (i.e. the building to be controlled.). A database in the ASSE may include information regarding the protocols or signal types that the client site can receive. Clearly, it is possible for the client site, at communication initiation phases, to determine the protocol type etc., to be used. TA 33 is connected to the CI 34, which with regard to the information received from the ASSE selects a suitable communication type and protocol. The server 31 may also run different types of user interfaces and Application Program Interfaces (API), such as JAVA API etc., for running applications to connect the clients to the networks.

As mentioned above, the CI may include any kind of communication device as it may need to establish communication with different types of communication devices at the client site. It may also include means to encrypt and decrypt the transmitted/received signals to secure the communication. The security may be needed, e.g. when alarm devices are controlled or special sites such as hospitals, banks, shops etc., are controlled.

The communication between the ASSE and SCP may be performed using TCP/IP (Transfer Control Protocol/Internet Protocol) or other suitable protocols. The communication from the CI 34 towards the client may be conducted through standard telephony connections 35 (PSTN functionality) or ADSL, ISDN, ATM, powerline etc., or a combination thereof. Moreover, the ASSE may directly communicate with the CI. Depending on the communication type used, it will be possible to substantially simultaneously send other data such as audio/video etc., when sending commands.

At the client site 36 a CI is arranged for receiving the control signals transmitted from the CI 34 of the Intelligent Network 30. The client site CI 37 converts the received signals to suitable control signals and transmits them to a LAN Controller 38, LANC, which can be a router, a transmitter, a base station or the like. If a powerline LAN is used, the LANC 38 is a powerline router of a known type. The LANC is then connected to the LAN, 39 interconnecting the equipments provided with controlling devices. The LAN may also comprise any other known network solutions. Moreover, a LAN may be expanded to a WAN (Wide Area Network).

The client site also includes normal telephone set 40 connection which functions in a normal way for connecting incoming/outgoing calls. The client site CI 37 communicates with the IN CI 37 through a normal telephone line 35 or directly via specially arranged communication paths, e.g. ISDN, ADSL etc.

The communication between the client site and the IN may be initiated as a normal telephony traffic between the client site and the network. The CI initiates the link so that a LAN protocol message can be transmitted to the AUS in the AS. The CI may be integrated with the LANC or TA.

In a preferred embodiment the CI may use built in hardware encryption, which is found in advanced PSTN modems. Additionally, it may be equipped with more or less sophisticated authentication control arrangements.

Following non limiting examples will disclose and clarify some advantages of the invention.

In one embodiment the client (a costumer) buys or subscribes to specific services from a Service Provider through the local PSTN provided with the IN. The costumer initiates a service at the Automating Service Server by dialling a special number and entering a service number, for example *123#. The costumer may then be asked for an identity code and Home Location Number if not stored in the server or the call is initiated from other place than the Home Location (stored in the server). Assume that the initiated service is doorbell-communication. When a doorbell is activated, and the costumer is not at home, a message is generated by the doorbell controller and transmitted to a powerline router via a doorbell's powerline. The router then transmits the signal to a communication device connected to the telephone line and further to the Automating Service Server at the IN. The server initiates an Automating Service. The message to the Automating Services from the doorbell may contain, besides information about the type of call, protocols used etc., information on the originating location and to which location (phone number) the doorbell message should be delivered. Then the server sends a signal to the IN to initiate a call to the indicated number and a communication between a door-phone (audio/video) and the costumers (external) location is established. The external location may be mobile (phone) location. The costumer may now speak to the visitor ringing the doorbell through the doorbell phone, preferably without the visitor noticing that the costumer is not at home. The service is terminated when the conversation is ended.

The arrangement may also be used to initiate other equipments, such as a video recorder, a satellite receiver, alarms etc.

The invention is not limited the shown embodiments but can be varied in a number of ways without departing from the scope of the appended claims and the arrangement and the method can be implemented in various ways depending on application, functional units, needs and requirements etc.

1. Arrangement in a communications network including an Intelligent Network IN (30) including means for establishing connection with a client site through a communication link (35),
characterised in,
that said client site (15, 16, 36) includes remotely controllable devices (17-23) arranged with controlling means, and said in (30) includes a service arrangement providing remote control services for controlling said devices in said client site (15, 16, 36):

2. Arrangement according to claim 1,
characterised in,
that said IN (30) includes an Automating Service Server (10, 31).

3. Arrangement according to claim 1,
characterised in,
that said Automating Service Server (10, 31) includes a database containing information about the client site.

4. Arrangement according to claim 3,
characterised in,
that said information includes at least a communication category with the client site, type of control means and services available.

5. Arrangement according to claim 1,
characterised in,
that it includes a traffic adapter (11, 33) for converting control signals form the IN to a signal adapted to client site control signals.

6. Arrangement according to any of claims 1-5
characterised in,
that it further includes a Communication Interface (12, 34) for communication with the client site(s).

7. Arrangement according to claim 6,
characterised in,
that said Communication Interface (12, 34) includes several types of communications devices.

8. Arrangement according to claim 6,
characterised in,
that said Communication Interface includes means for encrypting/decrypting signals to the client site(s).

9. Arrangement according to claim 5,
characterised in,
that said traffic adapter includes protocols for at least one or several of LONworks, Cebus and X-10.

10. Arrangement according to any of claims 1-9,
characterised in,
that the IN further includes Service Switching Point and Service Control Points.

11. Arrangement according to claim 10,
characterised in,
that Service Switching Point and Service Control Points communicates with the Automating Services Server through TCP/IP.

12. Arrangement according to claim 1,
characterised in,
that said client site includes a Communication Interface.

13. Arrangement according to claim 1,
characterised in,
that said client site includes a Local Area Network (39).

14. Arrangement according to claim 12,
characterised in,
that said Communication Interfaces communicate through one or several of PSTN, ISDN, ADSL, ATM, powerline or the like.

15. Arrangement according to claim 13
characterised in,
that said LAN is a powerline based network.

16. Communications network including a service provider part (35) and a client part (15, 16), and communications means to connect the service provider part (35) and the client part (15, 16),
characterised in,
that said client part includes at least one remotely controllable device (27-23), that the service provider part includes a service providing server (31) including information at least comprising data about said remotely controllable device and means to provide initiation commands through the communications means when initiated by a client, and that said service providing server is part of an Intelligent Network (IN).

17. The communications network according to claim 16,
characterised in,
that the client part includes a powerline network.

18. The communications network according to one of claims 16 or 17,
characterised in,
that the network is a telecommunication network.

19. A method for remotely controlling at least one device at a distant site through a communication network,
characterised in,
that the method includes the steps of:
arranging a remote management service in an Intelligent Network (IN),
connecting a service request from a client to said service in said IN,
generating a management command by means of said service, and
transmitting the command to a location specified by the client.

20. The method according to claim 19,
characterised in,
that the method further includes the steps of converting the management command into a form receivable by the controlled device.

21. The method according to claim 19,
characterised in,
that the service is provided through subscription or purchasing.

22. The method according to claim 19,
characterised in,
that the service is integrated into telephony services and provided through local exchanges of a public telephone network.
